(19) United States
(12) Patent Application Publication
(10) Pub. No.: US 2007/0291974 A1
(43) Pub. Date: Dec. 20, 2007

(54) EARPIECE FOR AN ELECTRONIC AUDIO PLAYER, WITH DECORATIVE ACCESSORY

(75) Inventor: Kenneth D. Eisenbraun, Bloomfield Village, MI (US)

Correspondence Address: GIFFORD, KRASS, SPRINKLE,ANDERSON & CITKOWSKI, P.C, PO BOX 7021, TROY, MI, 48007-7021, US

(73) Assignee: United Global Sourcing, Inc., Troy, MI (US)

(21) Appl. No.: 11/467,306

(22) Filed: Aug. 25, 2006

Related U.S. Application Data
(60) Provisional application No. 60/815,095, filed on Jun. 20, 2006.

(51) Int. Cl. H04R 25/00

(52) U.S. Cl. 381/370

(57) ABSTRACT

An earpiece incorporating a small speaker for use with an electronic device that generates audio signals, such as a cell phone, digital recording player, tape player or the like, which is adapted to be inserted in or held over a wearer's ear by a head strap, includes a jewelry-like decorative attachment secured to the outer side of the earpiece, so as to give the appearance of an earring. The decorative accessory may be removably attached to the earpiece by a separable fastener such as a snap fastener clip, magnetic clamp, Velcro fastener or the like. The decorative accessory may incorporate one or more light sources in the form of LEDs or the like, powered by a battery secured in either the earpiece of the accessory itself or an inline on/off volume control switch housing assembly. The light source may be powered constantly or intermittently based on motion of the wearer, sounds or the like.

### RELATED APPLICATION

This application claims priority of U.S. Provisional Patent Application Ser. No. 60/815,095 filed Jun. 20, 2006, which is incorporated herein by reference.

### FIELD OF THE INVENTION

This invention relates to earpieces for use with electronic audio signal generators and to decorative accessories secured to the earpieces.

### BACKGROUND OF THE INVENTION

Earpieces, either alone or as part of headsets, are often used with cell phones, digital music players, disc players and the like. These earpieces constitute electro-acoustic transducers, in the form of miniature speakers, for converting electrical signals from the associated electronic device, which is often worn in a pocket, attached to a belt or as a necklace, into sounds produced by a small speaker forming part of the earpiece. The earpieces may have one section that projects inwardly toward the eardrum and supports the earpiece in the wearer's head and an external section of a larger dimension that projects out of the ear, or they may be supported over the ear by headsets or the like.

Separately, jewelry-like earrings are a very common fashion accessory and may be selected so as to match a user's clothing or the like.

### SUMMARY OF THE INVENTION

The present invention is essentially directed toward a combination earpiece-earring. The earring is a jewelry-like item secured to the outer side of the earpiece or headset so as to be visible to observers of the user. The jewelry-like item may be formed integrally on the exterior of the earpiece or may be removably attached by a separable fastener such as a snap fastener, clip, magnetic clamp, Velcro fastener or the like. A decorative accessory may be formed with a complementary fastener so that it may be attached to the earpiece to be supported on the exterior of the earpiece or may be removed.

In one form of the invention, which is subsequently disclosed in detail, the decorative accessory is formed with light sources, preferably in the form of LEDs, which are visible when the accessory is worn with an earpiece. The light sources are preferably powered with batteries which may be either incorporated in the earpiece or in the jewelry item itself. When incorporated in the earpiece and used with jewelry-like accessories that are detachably secured to the earring, the separable fastener includes an electrical connection to provide the battery power from the earpiece to the accessory.

In one embodiment of the invention which will be subsequently disclosed in detail, circuitry is provided between the battery and the light source to power the light source intermittently, either in timed relation to the motion of the user or the beat of music being played over the earpiece or external sounds.

Other objectives, advantages and applications of the present invention will be made apparent by the following detailed description of preferred embodiments.

### BRIEF DESCRIPTION OF THE DRAWINGS

The description makes reference to the accompanying drawings in which:

FIG. 1 is a perspective view of a woman wearing a stereo headset pair formed in accordance with the present invention, shown from one side;

FIG. 2 is a side view of a headset and a decorative fastener adapted to be joined to the headset by a separable fastener, partially broken away;

FIG. 3 is a plan view of a stereo headset incorporating earring-like decorative accessories formed in accordance with my invention;

FIG. 4 is a side view of an earpiece formed in accordance with the present invention and incorporating a decorative jewelry-like earring affixed to the external side of the earpiece, with the jewelry item taking the configuration of a skull with LEDs associated with the eyes;

FIG. 5 is an exploded view of an earpiece formed in accordance with the present invention illustrating the manner of supporting the battery within the earpiece to power a separable jewelry-like item containing an LED; and

FIG. 6 is a schematic diagram of an earpiece formed in accordance with the present invention, a battery powering the earpiece, and a controller for intermittently connecting the LED to the battery.

### DETAILED DESCRIPTION OF PREFERRED EMBODIMENTS

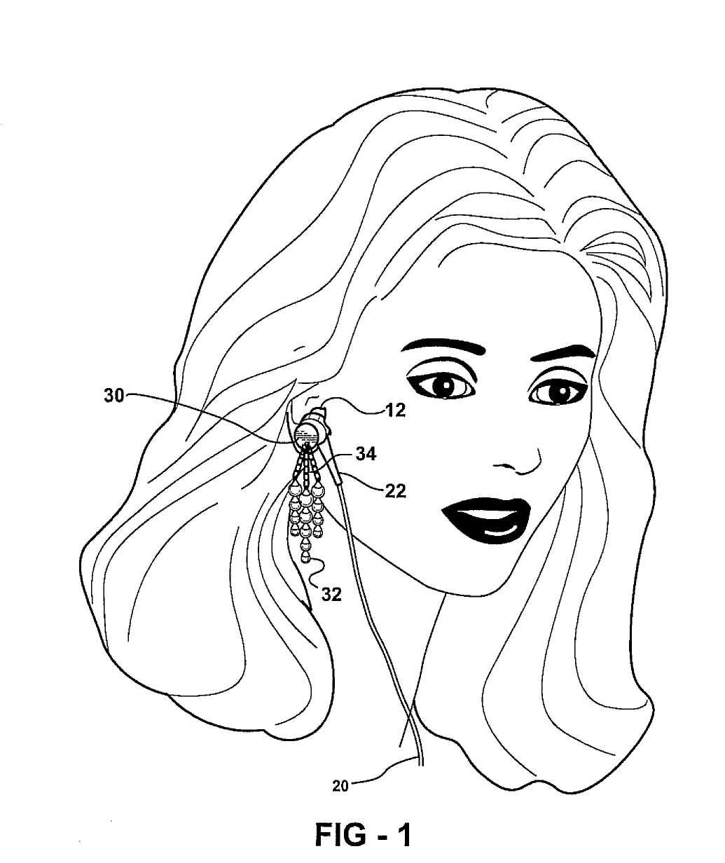

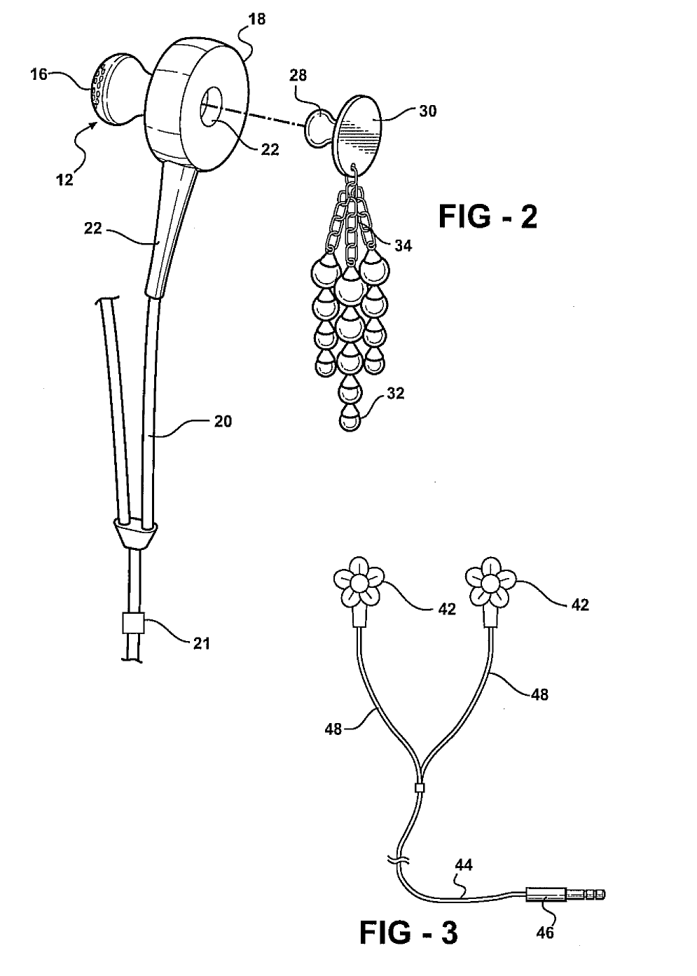

Referring to FIGS. 1 and 2, the present invention broadly comprises an earpiece 12 comprising a section 14 adapted to extend into a user's ear and having an interior section 16 formed with a pattern of holes or the like. A main body section 18 contains an electric-acoustic transducer, which may comprise a small electromagnetic speaker, a magnetostrictive speaker or the like. Electrical signals are provided to the speaker housing 18 through an electrical cord 20 which may have a connector 21 at its far end adapted to join to an electronic device which produces audio frequency signals such as a cell phone, MP3 player, disc player or the like. A resilient protective section 22 joins the cord 20 to the housing 18.

The forward section 24 of the housing 18, which is the section that projects away from the ear when the section 14 projects into the user's ear, is formed with a female snap fastener section 26. The snap fastener is adapted to removably retain a male snap fastener section 28 affixed to a decorative accessory 30. The decorative accessory may have an end 34 which supports a dangling section 32 which extends below the earpiece 12 when worn by the user.

As illustrated in FIG. 1, the headset 12 may be part of a stereo pair of headsets, one adapted for each ear. The headset 12 may project into the ear for retention purposes or a headband (not shown) may be used to press the earpiece against the ear.

The decorative section 30 and the dangle 32 provide a largely aesthetic function, although, as will be subsequently described, they may be connected to a motion detector which will control the illumination of a light source forming part of the decorative accessory.

As an alternative to securing a decorative accessory 30 to the headset 18 by a separable fastener 26-28, the decorative accessory may be permanently retained to the outer side of the headset. The advantage of making the decorative accessory separate from and attachable to the headset lies in the fact that different decorative accessories may be worn with the same headset and the decorative accessories may be merchandised separately from the headsets.

FIG. 3 illustrates a stereo headset pair generally indicated at 40 with the outer side of the headset shown to illustrate the decorative accessories 42 attached to each of the two earpieces of the stereo pair. A connecting cord 44, which has a jack 46 disposed at one end for attachment to an associated electronic device, splits into a pair of cords 48, one of which connects to each of the earpieces. Again, the decorative accessory shown may be permanently affixed to the earpiece or detachable by a separable fastener which may include a snap fastener, a clip, a Velcro fastener, or any other available form of separable fastener. The decorative accessories 42 take the form of flowers, but obviously any form of decorative attachment could be employed.

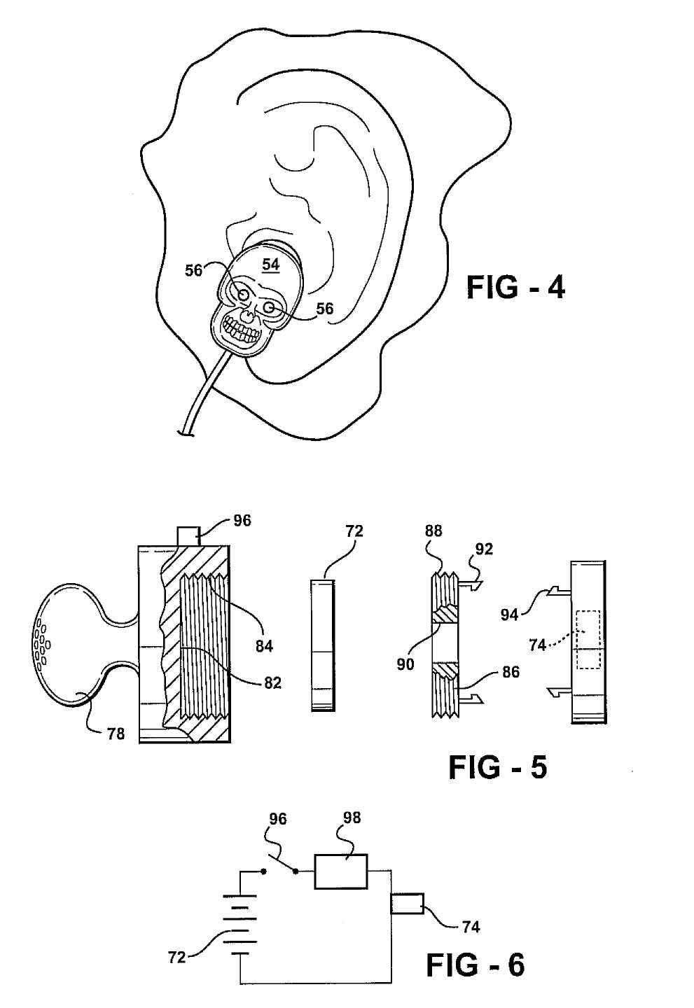

FIG. 4 illustrates an earpiece generally indicated at 50 disposed in a user's ear 52. Decorative accessory 54 associated with the earpiece has the appearance of a skull. The eyes of the skull are each equipped with a light source 56 which preferably constitutes an LED, but could constitute a small incandescent light bulb, a fluorescent light bulb, or any other known form of light generator. A battery associated with either the earpiece or the decorative accessory provides power to the lamps 56 either on a constant basis, after switching on, or intermittently, in timed relation to some effect such as motion of the user's head, sounds generated in the headset, external sounds or the like. Alternatively the lights may simply flash on and off in any desired pattern.

FIG. 5 illustrates in exploded form an earpiece generally indicated at 70 adapted to receive a battery 72 for powering an LED 74 associated with a detachable decorative accessory 76. The earpiece 70 includes a reduced section 78 adapted to extend into the user's ear, and a body 80. The body 80 has a recess 82 sized to receive a cylindrical battery 72. Screw threads 84 formed in the side walls of the recess 82 allow an outer section 86 with male threads 88 to be screwed into the recess to retain the battery 72. A pair of conductors 90 extending through the outer section 88 between its inner and outer sides make contact with the poles of the battery 72. A snap fastener male section 92 is attached to the outer side of the section 88 and mates with a complementary female snap fastener section 94 formed on the interior side of the decorative accessory 76. When the fastener sections 92 and 94 are joined, the conductors connect the battery to the LED 74 formed in the decorative accessory. The switch 96 on the earpiece 80 can energize and de-energize the light source 74.

FIG. 6 is a schematic diagram of a circuit useful with the decorative accessories containing light sources such as those shown in FIGS. 4 and 5. A battery 72 has one pole connected to one terminal of the light source 74. The other terminal is connected through switch 96 and, alternatively, through a light control circuit 98. The switch may be incorporated in the accessory, or in an in-line switch with or without a volume control. The light circuit control may be configured to turn on the light source 74 intermittently or in a preselected time pattern at such time as the switch 96 is closed. Alternatively, the unit 98 may incorporate a sensor such as a motion sensor which illuminates the light in timed relation to the motion of the user's head. It could also incorporate a sound sensor to control the illumination of the LED in timed relation to the beat of music being played over the earpiece by the player or as a function of ambient sounds.

It should be understood that the earpieces may be used singularly or in a pair and the pair may be monaural or stereo, depending upon the associated electronic device. The earpieces can be of the type illustrated in FIG. 5 which project into the head or could be retained by a conventional headset band (not shown).

Having thus described my invention I claim:

1. An earpiece incorporating an electrical-acoustic transducer, adapted for use in connection with an electronic device for generating audio signals, and having a first section adapted to be directed to the interior of a user's cars and an opposed external section, the improvement comprising:
a decorative jewel-like accessory secured to the outer side of the earpiece so as to be visible when a user is wearing the earpiece.

2. The earpiece of claim 1 in which the decorative accessory is detachably secured to the earpiece by a two-piece separable fastener having one section affixed to the exterior of the earpiece and the other complementary section of the fastener attached to the decorative accessory.

3. The earpiece of claim 1 in which the decorative accessory takes the form of an earring.

4. The decorative accessory of claim 3 where the earring includes a first section adapted to be affixed to the earpiece and a second section pivotably attached to the first section so as to dangle therefrom.

5. The earpiece of claim 1 adapted to be secured within the user's ear by means of an extending section adapted to be secured within the ear.

6. The earpiece of claim 1 adapted to be secured to the ear by a headband.

7. The earpiece of claim 1 which forms part of a pair of earpieces, one adapted to be secured to each ear of a user in which the electronic player generates a stereo signal.

8. The earpiece of claim 1 in which the decorative accessory includes a light source.

9. The earpiece of claim 8 in which the light source is powered by a battery supported within the earpiece.

10. The decorative accessory of claim 8 in which the light source is powered by a battery supported within the decorative accessory.

11. A decorative accessory adapted to be detachably secured to the exterior side of an earpiece for generating sounds based on an audio signal generated by an associated electronic device, the earpiece having an interior side adapted to engage the ear and an exterior side, the decorative accessory being adapted to be secured to the exterior side of the earpiece by means of a two-piece separable fastener, one piece associated with the exterior side of the earpiece and the other side associated with the decorative accessory, whereby the decorative accessory is displayed on the exterior of the earpiece when the earpiece is worn and may be removably detached therefrom.

12. The decorative accessory of claim 11 including a first section supporting one part of the separable fastener and a second section coupled to the first section by a hinge so as to dangle below the first section when the decorative accessory is worn.

13. The decorative accessory of claim 11 further comprising a light source attached to the decorative accessory and adapted to be energized by an associated battery to create a decorative effect.

14. The decorative accessory of claim 12 where the battery is disposed within the earpiece and joined to the decorative accessory by a connector.

15. The decorative accessory of claim 12 where the battery is supported on the decorative accessory.

16. The decorative accessory of claim 12 further including a controller disposed between the battery and the light source and adapted to control the illumination of the light source.

17. The decorative accessory of claim 16 wherein the controller includes a sensor for the motion of the user's head and controls the light source as a function of the motion.

18. The decorative accessory of claim 16 wherein the controller comprises a sonic detector and controls the light source as a function of incoming sounds.
